(19) United States
(12) Patent Application Publication
(10) Pub. No.: US 2025/0245462 A1
(43) Pub. Date: Jul. 31, 2025

(54) STORAGE MEDIUM, INFORMATION PROCESSING APPARATUS, AND SYSTEM

(71) Applicant: CANON KABUSHIKI KAISHA, Tokyo (JP)

(72) Inventor: SHINSAKU KOBAYASHI, Chiba (JP)

(21) Appl. No.: 19/019,682

(22) Filed: Jan. 14, 2025

(30) Foreign Application Priority Data
Jan. 25, 2024 (JP) 2024-009603

(51) Int. Cl. G06K 15/02; G06F 3/12

(52) U.S. Cl. CPC G06K 15/1809; G06F 3/1205; G06F 3/1256

(57) ABSTRACT

The present invention is directed to a non-transitory computer-readable storage medium storing a computer program that extends functions of a generative AI service, the computer program causing a computer of an information processing apparatus to function so as to specify a print range upon receiving a print request via the generative AI service, generate a print job based on the print request and the print range, register the generated print job with a print server, obtain information related to a connection destination for executing the print job from the print server, and present the print job and the information related to the connection destination to a user via the generative AI service.

### BACKGROUND OF THE INVENTION

### Field of the Invention

The present invention relates to a storage medium, an information processing apparatus, and a system that extend the functions of an artificial intelligence system.

### Description of the Related Art

There is a known artificial intelligence system called generative AI, which can generate text, images, or other media in reply to a prompt. Regarding generative AI such as ChatGPT®, functions can be extended using plug-ins. For example, when a sentence including the keyword “print” has been input to the generative AI as an instruction, a plug-in related to printing is selected, and the plug-in executes processing to which the generative AI cannot reply as a substitute; in this way, extension of functions is enabled.

Meanwhile, regarding an image forming apparatus, printing can be performed by inputting print data from a cloud server. For example, Japanese Patent Laid-Open No. 2018-128843 suggests a technique to enable printing of a document managed in a cloud server in a conversational form involving a chat.

However, in a case an output such as text generated by generative AI is printed using an image forming apparatus, a user or the like needs to make a copy in a file or the like, and execute printing from, for example, a print driver. That is to say, in order to execute printing, the user needs to go to the trouble of making a copy of an output generated by generative AI.

### SUMMARY OF THE INVENTION

The present invention enables realization of a mechanism that causes an image forming apparatus to perform suitable printing of an output from generative AI.

One aspect of the present invention provides a non-transitory computer-readable storage medium storing a computer program that extends functions of a generative AI service, the computer program causing a computer of an information processing apparatus to function so as to specify a print range upon receiving a print request via the generative AI service, generate a print job based on the print request and the print range, register the generated print job with a print server, obtain information related to a connection destination for executing the print job from the print server, and present the print job and the information related to the connection destination to a user via the generative AI service.

Another aspect of the present invention provides an information processing apparatus that executes a computer program that extends functions of a generative AI service, the information processing apparatus comprising: one or more memory devices that store a set of instructions; and one or more processors that execute the set of instructions to specify a print range upon receiving a print request via the generative AI service, generate a print job based on the print request and the print range, register the generated print job with a print server, obtain information related to a connection destination for executing the print job from the print server, and present the print job and the information related to the connection destination to a user via the generative AI service.

Still another aspect of the present invention provides a print system including an information processing apparatus, a print server, and an image forming apparatus, the information processing apparatus providing a generative AI service to a user terminal and comprising: one or more first memory devices that store a set of instructions of a computer program that extends functions of the generative AI service; and one or more first processors that execute the set of instructions to specify a print range upon receiving a print request via the generative AI service, generate a print job based on the print request and the print range, register the generated print job with a print server, obtain information related to a connection destination for executing the print job from the print server, and present the print job and the information related to the connection destination to a user via the generative AI service, the print server comprising: one or more second memory devices that store a set of instructions; and one or more second processors that execute the set of instructions to provide the information related to the connection destination when the print job has been registered, and input the print job to the image forming apparatus when the user has accessed the information related to the connection destination.

Further features of the present invention will be apparent from the following description of exemplary embodiments with reference to the attached drawings.

### BRIEF DESCRIPTION OF THE DRAWINGS

FIG. 1 is a diagram showing a system configuration according to an embodiment.

FIG. 2 is a diagram showing a configuration of an MFP according to an embodiment.

FIG. 3 is a diagram showing a configuration of a user terminal according to an embodiment.

FIG. 4 is a diagram showing a configuration of a generative AI server according to an embodiment.

FIG. 5 is a diagram showing a configuration of an extension application server according to an embodiment.

FIG. 6 is a diagram showing a configuration of a cloud print server according to an embodiment.

FIG. 7 is an example of a screen which is displayed on the user terminal and which shows a dialogue with the generative AI server according to an embodiment.

FIG. 8 is a sequence diagram of printing of a document according to an embodiment.

FIG. 9 is an example of a screen which is displayed on the user terminal and which shows a dialogue with the generative AI server according to an embodiment.

FIG. 10 is an example of a screen displayed on the user terminal after print logs have been designated according to an embodiment.

FIG. 11 is a sequence diagram of printing of a document according to an embodiment.

FIG. 12 is a flowchart related to the extension application server according to an embodiment.

FIG. 13 is a flowchart related to the extension application server according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### System Configuration

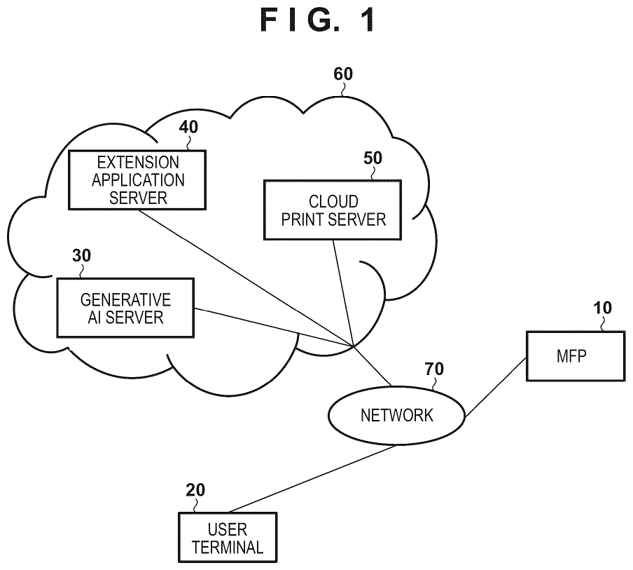

The following describes a first embodiment of the present invention. The present embodiment will be described using a multi function peripheral (MFP), which has printing, scanning, and FAX functions, as an example of an image processing apparatus. FIG. 1 shows an example of an overall configuration diagram of a print system that provides a print service via a generative AI service according to the present invention. The present print system is configured to include an image forming apparatus 10, which is a print apparatus or the like, a user terminal 20, a generative AI server 30, an extension application server 40, and a cloud print server 50. They are connected to one another via a network 70 in such a manner that they can mutually communicate. The network 70 is a wireless or wired network composed of a WAN or a LAN.

The image forming apparatus 10 represents a print apparatus that has a function of printing an image notified by the cloud print server 50. The user terminal 20 represents an information terminal, such as a smartphone, a tablet terminal, and a personal computer, when a user uses a generative AI service like ChatGPT. The user accesses the generative AI server 30 in a cloud by operating the user terminal 20, and executes a generative AI application. The user terminal 20 and the generative AI server 30 are connected to a wired or wireless communication network, and can transmit/receive data to/from each other. Although public lines on the Internet are assumed as an example of the communication network in the present embodiment, dedicated lines may be used.

The generative AI server 30 is a cloud server (an information processing apparatus) that is arranged in a cloud 60 and provides generative AI like ChatGPT, which is text generative AI. The generative AI server 30 provides a service in coordination with the extension application server 40. The generative AI server 30 interprets a message transmitted from the user terminal 20, generates an appropriate answer, and displays the answer on a screen of the user terminal 20 as a reply. Furthermore, the generative AI server 30 can extend functions by communicating with the extension application server 40.

The extension application server 40 is a cloud server (an information processing apparatus) arranged in the cloud 60, and has a function of providing additional functions (plug-ins) to the generative AI server 30. The generative AI server 30 incorporates predetermined plug-ins in coordination with the extension application server 40; in this way, it can execute processing that cannot be executed solely by itself. Upon receiving a print request from the user terminal 20, the cloud print server 50 notifies the image forming apparatus 10 of arrival of a print job. In accordance with the notification from the cloud print server 50, the image forming apparatus 10 receives the print job from the cloud print server 50, and executes printing. Note that although the present description is provided using an example in which each type of server is provided individually, each type of server may be provided integrally with another server. For example, the generative AI server 30 and the extension application server 40 may be provided integrally.

### Hardware Configuration of Image Forming Apparatus

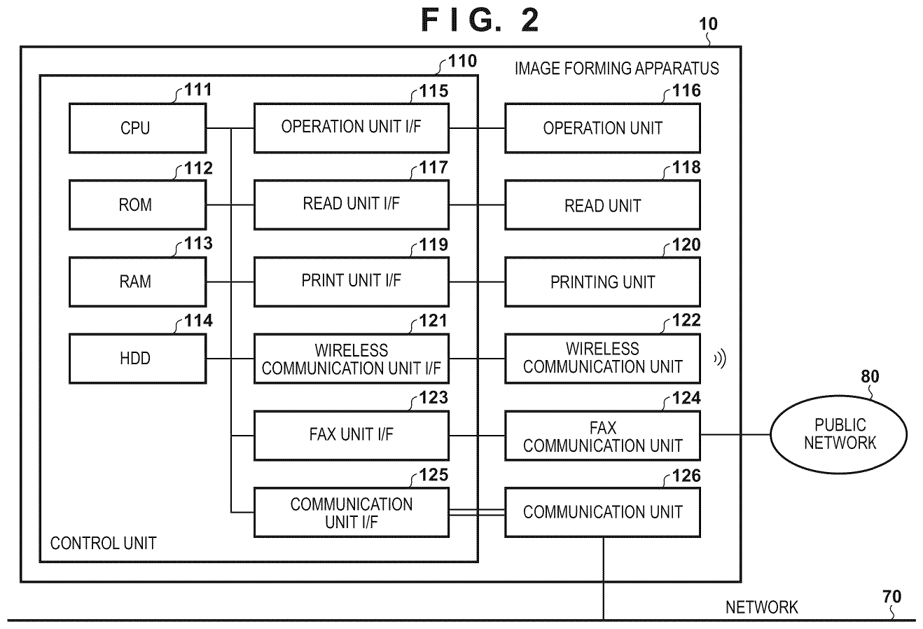

An example of a hardware configuration of the image forming apparatus 10 according to the present embodiment will be described with reference to FIG. 2. The image forming apparatus 10 includes a control unit 110, an operation unit 116, a read unit 118, a print unit 120, a wireless communication unit 122, a FAX communication unit 124, and a communication unit 126. The control unit 110 includes a CPU 111, a ROM 112, a RAM 113, an HDD 114, an operation unit I/F 115, a read unit I/F 117, a print unit I/F 119, a wireless communication unit I/F 121, a FAX unit I/F 123, and a communication unit I/F 125.

The control unit 110, which includes the CPU 111, controls the operations of the entire image forming apparatus 10. The CPU 111 reads out control programs stored in the ROM 112 or the HDD 114 into the RAM 113, and performs various types of control, such as read control and print control. The ROM 112 stores control programs that can be executed by the CPU 111. Furthermore, the ROM 112 also stores a boot program, font data, and the like. The RAM 113 is a main storage memory, and is used as a temporary storage area for deploying various types of control programs stored in a working area, the ROM 112, and the HDD 114. The HDD 114 stores image data, print data, various types of programs, various types of addresses, and various types of setting information. The HDD 114 is a storage medium, and may be a solid-state drive (SSD), an embedded multi-media card (eMMC), or the like instead of an HDD.

Note that although it is assumed that the image forming apparatus 10 according to the present embodiment executes each type of processing shown in the later-described flowcharts while one CPU 111 uses one memory (RAM 113), no limitation is intended by this. For example, each type of processing can be executed by causing a plurality of CPUs, RAMS, ROMs, and HDDs to operate in coordination with one another. Also, a part of processing may be executed using a hardware circuit, such as an ASIC and an FPGA.

The operation unit I/F 115 connects between the operation unit 116 that includes, for example, a display unit like a touch panel and hardware keys, and the control unit 110. The operation unit 116 displays information for the user, and detects inputs from the user. The read unit I/F 117 connects between the read unit 118, which is like a scanner for example, and the control unit 110. The read unit 118 reads an image of an original, and the CPU 111 converts this image into image data, such as binary data. The image data that has been generated based on the image read by the read unit 118 is transmitted to an external apparatus, and printed on recording paper. The print unit I/F 119 connects between the print unit 120, which is like a printer for example, and the control unit 110. The CPU 111 transfers image data (print data) stored in the RAM 113 to the print unit 120 via the print unit I/F 119. The print unit 120 prints an image based on the transferred image data on recording paper fed from a feeding cassette.

The wireless communication unit I/F 121 is an I/F for controlling the wireless communication unit 122, and wirelessly connects the control unit 110 to an external wireless device. The FAX unit I/F 123 is connected to a public network 80 by controlling the FAX communication unit 124. The FAX unit I/F 123 is an I/F for controlling the FAX communication unit 124, and can be connected to a public network, control facsimile communication protocols, and so on by controlling a modem and an NCU for facsimile communication.

The communication unit I/F 125 connects between the control unit 110 and the network 70. The communication unit I/F 125 allows the communication unit 126 to transmit image data and various types of information inside the apparatus to an external apparatus in the network 70, and receive print data and information in the network 70 from an external apparatus in the network 70. As a method of transmission/reception via the network 70, transmission/reception using an electronic mail (e-mail) and file transmission using other protocols (e.g., FTP, SMB, WEBDAV, and the like) can be performed. Furthermore, image data and message data can also be transmitted/received in the network 70 through accesses from the user terminal 20 and the generative AI server 30 via HTTP communication. In addition, it is possible to configure various types of settings of the image forming apparatus 10 (a remove UI function) by accessing the image forming apparatus 10 from a web browser of the user terminal 20 via a network.

### Hardware Configuration of User Terminal

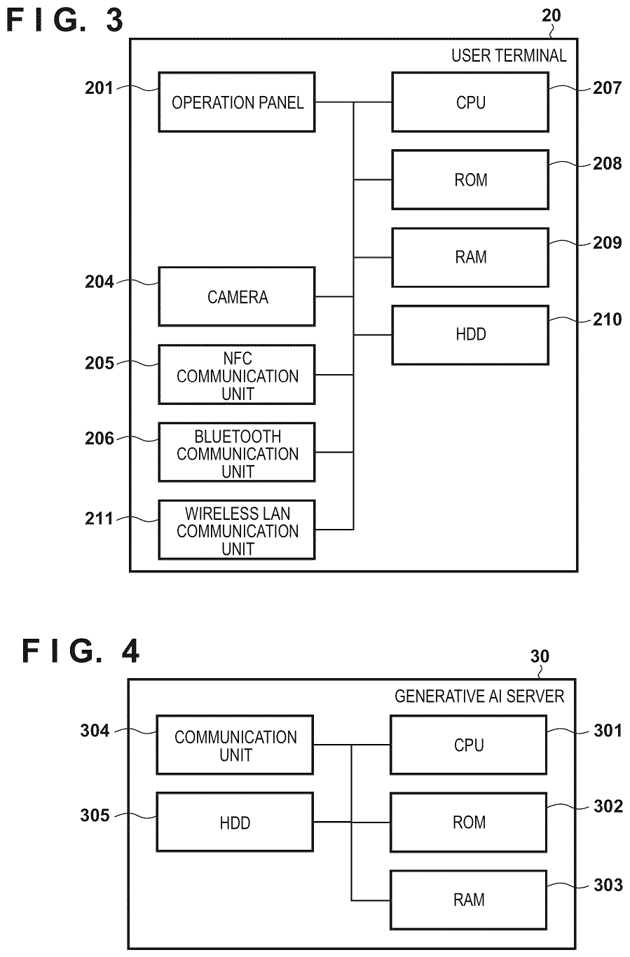

An example of a hardware configuration of the user terminal 20 according to the present embodiment will be described with reference to FIG. 3. Note that although the user terminal 20 according to the present embodiment is assumed to be an apparatus like a smartphone, a tablet PC, or the like, it may be another apparatus as long as it is an information processing apparatus that can be connected to the network 70 using, for example, Wi-Fi communication. The user terminal 20 includes an operation panel 201, a camera 204, an NFC communication unit 205, a Bluetooth® communication unit 206, a CPU 207, a ROM 208, a RAM 209, an HDD 210, and a wireless LAN communication unit.

The CPU 207 reads out control programs stored in the ROM 208, and executes various types of processing for controlling the operations of the user terminal 20. The ROM 208 stores the above-described control programs. The RAM 209 is used as a temporary storage area, such as a main memory and a working area, for the CPU 207. The HDD 210 stores various types of data, such as photographs and electronic documents.

The operation panel 201 has a touch panel function capable of detecting a touch operation of a user, and displays various types of screens provided by an OS and an electronic mail transmission application. Also, the operation panel 201 is used to conform information stored in the generative AI server 30. The user can input a desired operation instruction to the user terminal 20 by inputting a touch operation to the operation panel 201. Note that the user terminal 20 includes non-illustrated hardware keys, and the user can also input an operation instruction to the user terminal 20 using these hardware keys.

The camera 204 captures images in accordance with an image capturing instruction from the user. Photographs captured by the camera 204 are stored in a predetermined area in the HDD 210. Furthermore, it is also possible to obtain information from a QR code read by the camera 204 using a program capable of analyzing QR codes.

The user terminal 20 can exchange data with various types of peripheral devices via the NFC communication unit 205, Bluetooth communication unit 206, and wireless LAN communication unit 211. The Bluetooth communication unit 206 of the user terminal 20 may support Bluetooth Low Energy (BLE).

### Hardware Configuration of Generative AI Server

An example of a hardware configuration of the generative AI server 30 according to the present embodiment will be described with reference to FIG. 4. The generative AI server 30 includes a CPU 301, a ROM 302, a RAM 303, a communication unit 304, and an HDD 305.

The CPU 301 executes processing for controlling an operation of generating an appropriate reply using control programs stored in the ROM 302 and a training model stored in the HDD 305. The ROM 302 stores the above-described control programs. The RAM 303 is used as a temporary storage area, such as a main memory and a working area, for the CPU 301. The HDD 305 stores various types of data, such as logs of messages transmitted from the training model, the generative AI application, and the user terminal 20, and generated responses.

Data can be exchanged with various types of devices, such as the user terminal 20, image forming apparatus 10, and extension application server 40, via the communication unit 304. Note that the communication unit 304 may perform wired communication using Ethernet®, or may perform wireless communication, such as Wi-Fi.

### Hardware Configuration of Extension Application Server

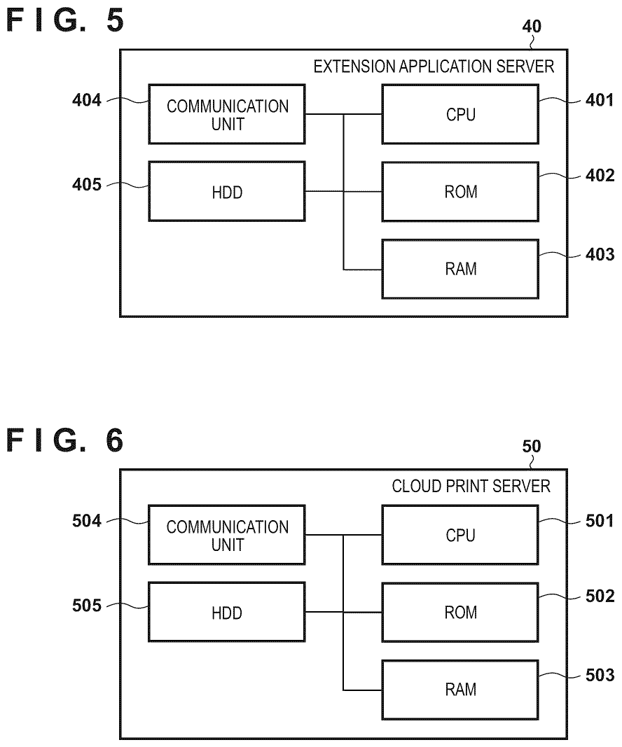

An example of a hardware configuration of the extension application server 40 will be described with reference to FIG. 5. The extension application server 40 includes a CPU 401, a ROM 402, a RAM 403, a communication unit 404, and an HDD 405.

The CPU 401 reads out control programs stored in the ROM 402, and executes processing in accordance with a message received from the generative AI server 30. The ROM 402 stores the above-described control programs. The RAM 403 is used as a temporary storage area, such as a main memory and a working area, for the CPU 401. The HDD 405 stores, for example, the contents of messages received from the generative AI server 30 or a part thereof. Data can be transmitted/received to/from various types of equipment, such as the generative AI server 30, via the communication unit 404.

### Hardware Configuration of Cloud Print Server

An example of a hardware configuration of the cloud print server 50 will be described with reference to FIG. 6. The cloud print server 50 includes a CPU 501, a ROM 502, a RAM 503, a communication unit 504, and an HDD 505.

The CPU 501 reads out control programs stored in the ROM 502, and enables reception of print jobs from the user terminal 20 and obtainment of stored print jobs. The ROM 502 stores the above-described control programs. The RAM 503 is used as a temporary storage area, such as a main memory and a working area, for the CPU 501. The HDD 505 stores, for example, print jobs received from the user terminal 20. Data can be transmitted/received to/from various types of equipment, such as the generative AI server 30, via the communication unit 504.

### Print Instruction

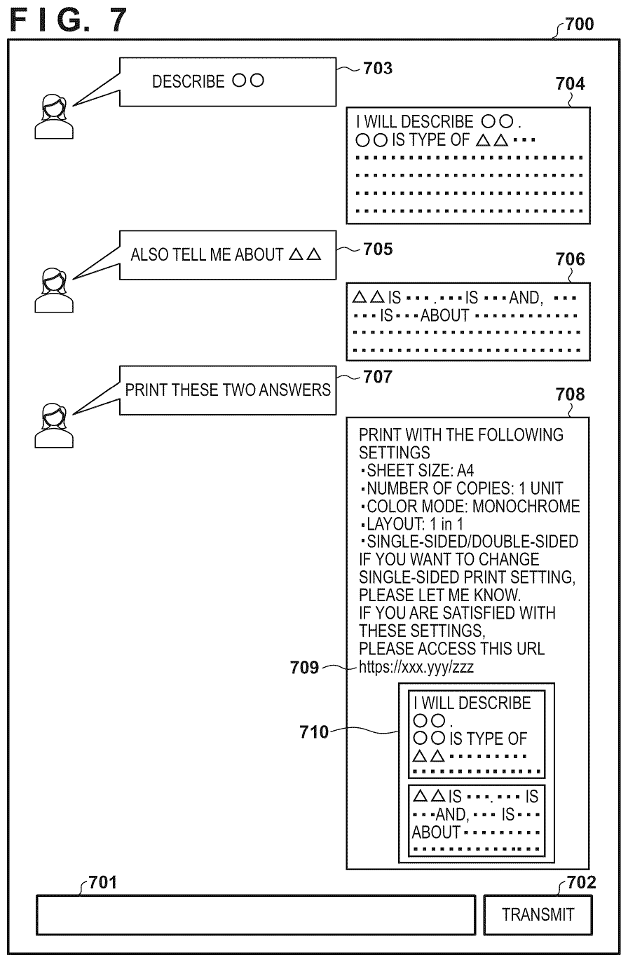

With reference to FIG. 7, a description is now given of a dialogue between a user and the generative AI server 30 when instructing the generative AI server 30 according to the present embodiment to perform printing. Accessing the generative AI server 30 from a browser operating on the user terminal 20 causes the operation panel 201 to display a screen 700. The screen 700 displays message sentences input from the user terminal 20 and responses generated by the generative AI server 30 in a chronological order (in a dialogue form).

A prompt input field 701 is an input field intended for the user to input an instruction sentence (prompt) to the generative AI server 30. The user performs an input in the form of text in natural language from the operation panel 201 of the user terminal 20. The user can input an instruction sentence by operating a touch panel of the user terminal 20. A transmission button 702 is a button that acts as a trigger for transmitting a prompt input to the prompt input field 701 to the generative AI server 30.

Inquiry sentences 703 and 705 are prompts that have been transmitted from the user terminal 20 and request a reply from the generative AI server 30. Answer sentences 704 and 706 are responses generated by the generative AI server, and are answers corresponding to the contents of inquiries that were made by the user in the inquiry sentences 703 and 705.

A print request prompt 707 is an example of a prompt for instructing the generative AI server 30 to perform printing. This prompt needs to include a range of logs to be printed by the generative AI server 30, and an indication that it is to be printed. In the present embodiment, the content of this prompt represents an instruction for printing the answer sentences 704 and 706, which are two immediately preceding responses. Although it is assumed here that the answer sentences to be printed by an instruction and the print request prompt are in the same conversation log, a past log stored in the HDD 305 of the generative AI server 30 may be a print target.

A print request response 708 is a response to the print request prompt 707, and has been generated by the generative AI server 30 in coordination with the extension application server 40. The print request response 708 includes settings of printing to be performed from now, as well as a reserved job URL 709 and a preview image 710, which will be described later.

The reserved job URL 709 is a URL pointing to a print job stored in the cloud print server 50. The user can perform cloud printing (inputting of the print job from the cloud print server 50 to the image forming apparatus 10) by accessing this URL. Furthermore, in a case where print settings of the reserved job are to be changed as well, the change is made by transmitting an HTTP request to the reserved job URL. The preview image 710 is a preview image showing an image of an output material for a case where printing is performed under the current print settings. This image allows the user to acknowledge the rough finish of the output material before printing.

### Sequence

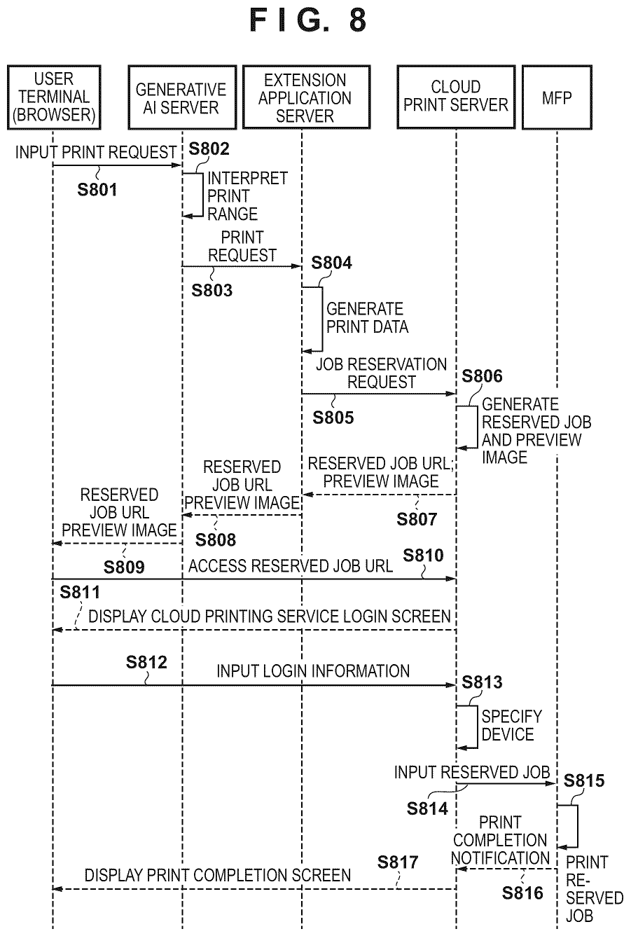

With reference to FIG. 8, a description is now given of a dialogue between system constituent elements according to the present embodiment after a user has instructed the generative AI server 30 to perform printing until a print job is actually input to the image forming apparatus 10. Note that in the sequence described below, in a case where the generative AI server 30 and the extension application server 40 are provided integrally, the two apparatuses are controlled in an integrated manner.

In step S801, the user terminal 20 transmits, to the generative AI server 30, the content that has been input to the print request prompt 707 in accordance with a user input performed via a browser. Subsequently, in step S802, the generative AI server 30 interprets the content of the print request prompt 707, and specifies the answer sentences 704 and 706 as logs to be printed, that is to say, a print range. In the case of the print request prompt 707, it is interpreted that only logs of responses apply based on “answers”, and two logs preceding the print request prompt 707 are to be printed based on “these two”.

The following examples are possible as other methods of specifying logs to be printed (a print range). For example, in a case where such terms as “inquiry and answer” and “exchange” are included, it can be interpreted that an instruction for printing a pair of a prompt and a response has been issued. Also, a range of logs to be printed can be interpreted from a combination of terms indicating a criterion, such as “from the top” and “latest”, and terms indicating a number and an amount. Furthermore, it is also possible that a specific log is interpreted as a target based on a term indicating the content of a prompt or a response, as in a case where the answer sentence 704 is printed based on “answer related to ○○” Note that in a case where terms for specifying a print range are insufficient, an inquiry may be made to the user so as to compensate for the insufficient terms. Alternatively, a plurality of options for the print range may be provided to the user, and the user may be caused to make a selection therefrom.

In step S803, the generative AI server 30 transmits a print request to the extension application server 40. At this time, text data of the answer sentences 704 and 705 is transmitted together. In step S804, the extension application server 40 generates print data from the received text data of the answer sentences 704 and 705. The print data is in a data format that can be accepted by the cloud print server 50, and can be, for example, a PDF file. Next, default print settings are stored as the current print settings. Although one piece of print data is generated from a plurality of pieces of log data that have been received in the present embodiment, one piece of print data may be generated for one piece of log data.

In step S805, the extension application server 40 transmits a job reservation request to the cloud print server 50. At this time, the print data generated in step S804 and the current print settings are transmitted together. In step S806, the cloud print server 50 registers a reserved job based on the print data and the current print settings received from the extension application server 40. Also, the cloud print server 50 generates and stores the reserved job URL 709 pointing to the reserved job and the preview image 710, which is an image of an output material of the reserved job. In step S807, the cloud print server 50 returns the reserved job URL 709 and the preview image 710 to the extension application server 40 as a response to the job reservation request. In step S808, the extension application server 40 stores the reserved job URL 709 in association with a Job ID, and returns the reserved job URL 709 and the preview image 710 to the generative AI server 30 as a response to the print request. In step S809, the generative AI server 30 returns the reserved job URL 709 and the preview image 710 to the user terminal 20 as a response to the print request prompt 707. The user terminal 20 displays the print request response 708 on the operation panel 201.

In step S810, the user terminal 20 accesses the reserved job URL 709 in accordance with a user input performed via the browser. In step S811, the cloud print server 50 returns a login screen for a cloud print service (not shown) to the user terminal 20. In step S812, the user terminal 20 accepts login information in accordance with a user input performed via the browser, and logs into the cloud print service. Note that in a case where the user does not have an account for the cloud print service, a task of creating an account, which is not shown, is required. In step S813, the cloud print server 50 specifies an MFP used by the user from information of the user who has logged in. Note that in a case where the user has not registered the MFP, a task of registering the MFP, which is not shown, is required. Also, in a case where a plurality of MFPs have been registered, an MFP may be selected by making an interactive exchange, which is not shown, with the user.

In step S814, the cloud print server 50 inputs the reserved job to the specified image forming apparatus 10. In step S815, the image forming apparatus 10 executes printing in accordance with the reserved job input from the cloud print server 50. In step S816, the image forming apparatus 10 notifies the cloud print server 50 of completion of printing of the reserved job. In step S817, the cloud print server 50 returns a print completion screen (not shown) to the user terminal 20, causes the print completion screen to be displayed, and ends the present sequence.

### Processing Procedure of Extension Application Server

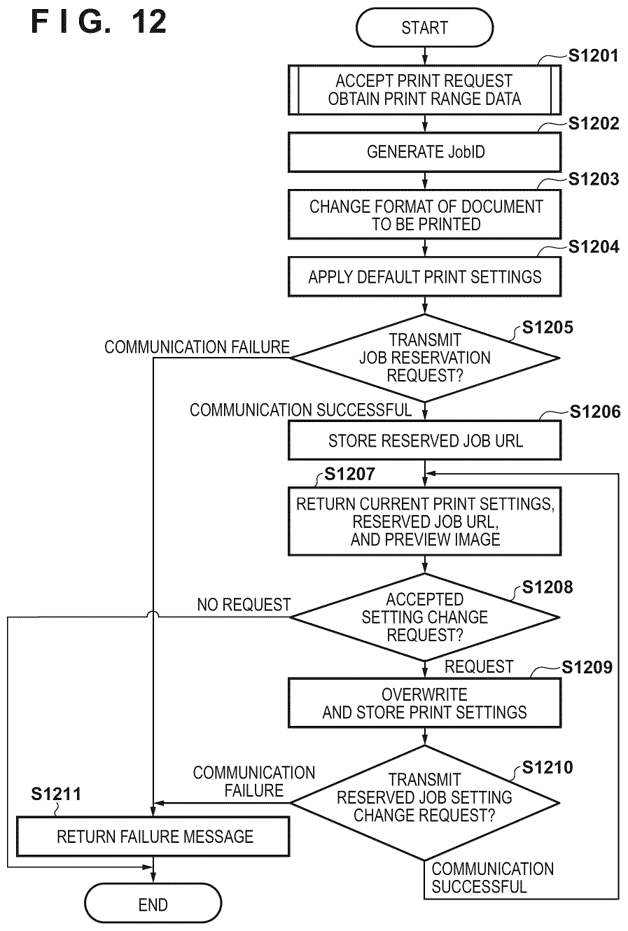

A processing procedure of the extension application server 40 according to the present embodiment will be described with reference to FIG. 12. The processing described below is realized by, for example, the CPU 401 reading out a program stored in the ROM 402 into the RAM 403 and executing the program. Also, the following processing is realized by executing a plug-in that extends functions of the generative AI server 30. The present embodiment will be described under the assumption that this plug-in (program) is managed and executed by the extension application server 40; this, however, is not intended to limit the present invention. For example, the plug-in managed by the extension application server 40 may be installed on the generative AI server 30 and executed on the generative AI server 30. Alternatively, the generative AI server 30 and the extension application server 40 may be provided integrally; in this case, the integrated server controls management, installation, and execution of the plug-in.

In step S1201, the CPU 401 accepts a print request from the generative AI server 30, and obtains text data that is a print target. Here, the text data that is the print target is, for example, text data of logs representing a print range. Note that the following describes an example in which log data representing a print range is obtained from the generative AI server 30; this, however, is not intended to limit the present invention. For example, the extension application server 40 may specify a print range corresponding to a user dialogue from log data. In this case, it is desirable that the generative AI server 30 transmits, to the extension application server 40, the location of storage of all pieces of data of logs that can be the target, and the content of a user input related to a print instruction. Based on these pieces of information, the extension application server 40 specifies a print range and obtains necessary log data from the location of storage. Alternatively, a request for information indicating necessary data may be sent to the generative AI server 30, and log data may be received as a reply thereto.

In step S1202, the CPU 401 generates and stores a unique Job ID. In step S1203, the CPU 401 generates print data by converting the text data that is the print target into a format that can be accepted by the cloud print server 50, and stores the print data into a memory, such as the RAM 403 and the HDD 405, in association with the Job ID. Note that various types of storage processing described below are similarly executed with respect to a memory, such as the RAM 403 and the HDD 405. The memory may be an external memory connected to the extension application server 40. Furthermore, in step S1204, the CPU 401 reads out default print settings, and stores them as the current print settings in association with the Job ID.

Next, in step S1205, the CPU 401 transmits a job reservation request to the cloud print server 50. At this time, the CPU 401 transmits the converted print data and the current print settings together. In a case where communication has been successful and the reserved job URL 709 and the like have been returned from the cloud print server 50, processing proceeds to step S1206. On the other hand, in a case where an error notification has been provided by the cloud print server 50, or in a case where a reply is not received within a predetermined time period, it is determined that communication has failed, and processing proceeds to step S1211.

In step S1206, the CPU 401 stores the reserved job URL 709 in association with the Job ID. In step S1207, the CPU 401 returns the current print settings, the reserved job URL 709, and the preview image 710 as a response to the generative AI server 30. In step S1208, the CPU 401 determines whether a request for change in print settings has been accepted from the generative AI server 30. In a case where the request for change in print settings has been accepted, processing proceeds to step S1209; in a case where this request has not been accepted, processing of the present flowchart is ended.

In step S1209, the CPU 401 reads out the current print settings associated with the Job ID, reflects the requested change in settings therein, and stores the resultant print settings by way of overwriting. In step S1210, the CPU 401 reads out the reserved job URL 709 associated with the Job ID, and transmits a request for change in reserved job settings to the cloud print server 50. At this time, the CPU 401 transmits the converted print data and the print settings that reflect the change together. In a case where communication has been successful and the reserved job URL 709 and the like have been returned from the cloud print server 50, processing proceeds to step S1207. On the other hand, in a case where communication has failed in the above-described manner, processing proceeds to step S1211. In step S1211, the CPU 401 returns a failure message to the generative AI server 30, and ends processing of the present flowchart.

As described above, a computer program according to the present embodiment is a computer program that extends functions of a generative AI service, and causes a computer to function so as to specify a print range upon receiving a print request via the generative AI service. Also, the present computer program causes the computer to function so as to generate a print job based on a print request and a print range, and register the generated print job with a print server. Furthermore, the present computer program causes the computer to function so as to obtain, from the print server, information related to a connection destination for executing the print job, and presents the print job and the information related to the connection destination to a user via the generative AI service. This can reduce the trouble that the user goes to when printing information generated by generative AI on an information forming apparatus. In this way, the present embodiment can provide a mechanism that causes an image forming apparatus to perform suitable printing of an output from the generative AI.

### Second Embodiment

The following describes a second embodiment of the present invention. The above first embodiment has been described in relation to an example in which a print range is obtained in accordance with the input content included in a print request from a user. On the other hand, the present embodiment will be described in relation to a mode in which, after a print request has been accepted, a user is provided with a plurality of options that act as a print range, and a print range is obtained in accordance with a user selection.

### Print Instruction

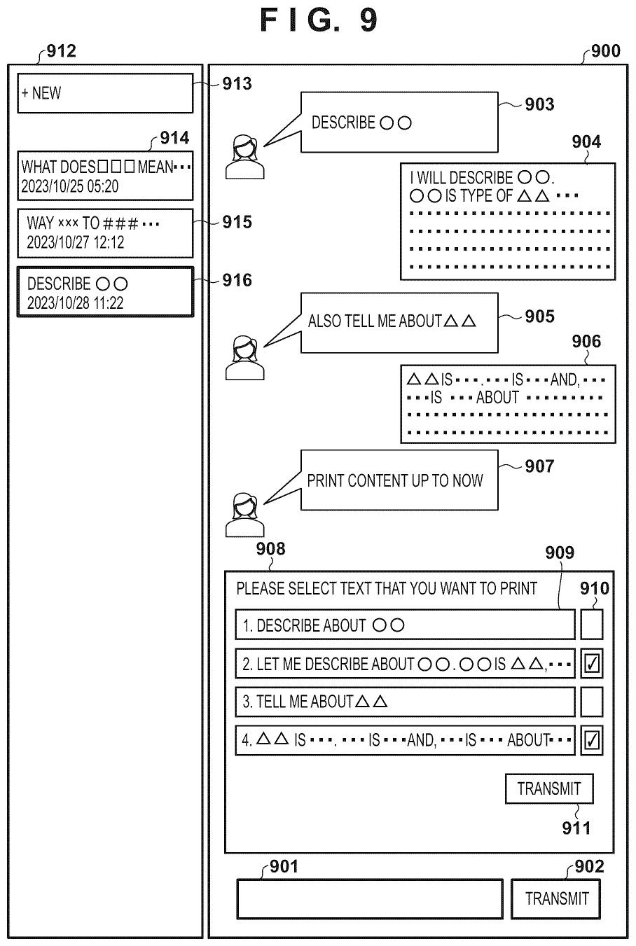

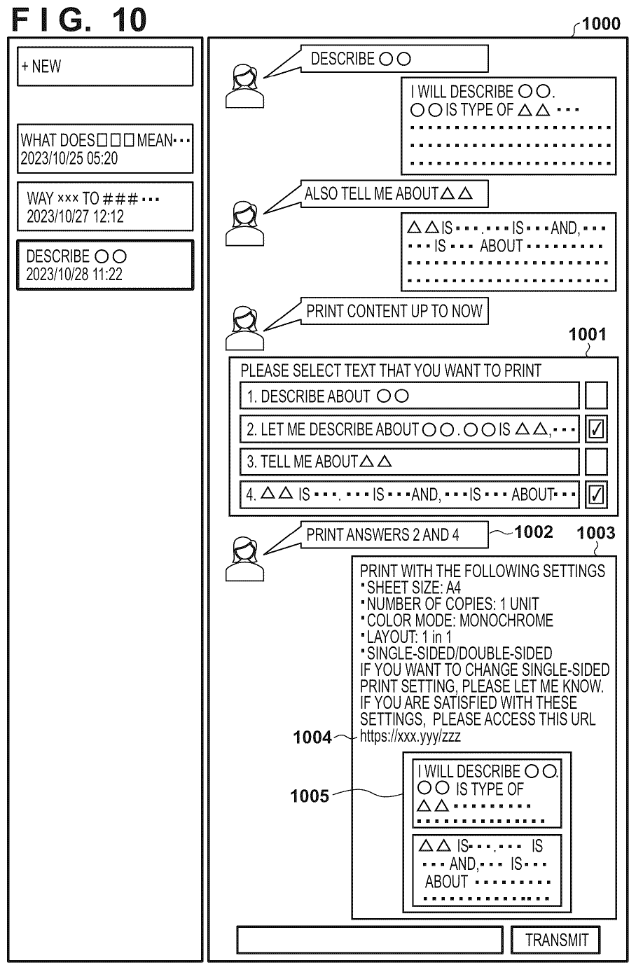

With reference to FIG. 9 and FIG. 10, a description is now given of a dialogue screen for a case where the extension application server 40 according to the present embodiment accepts a selection of logs to be printed from a user via the generative AI server 30. Accessing the generative AI server 30 from a browser operating on the user terminal 20 causes the operation panel 201 to display a dialogue screen 900. The interactive screen displays message sentences (input contents) that have been input and transmitted by the user terminal 20, and responses (replies) generated by the generative AI server 30 and the extension application server 40, in a chronological order.

A prompt input field 901 is an input field intended for the user to input an instruction sentence (prompt) to the generative AI server 30. The user performs an input in the form of text in natural language from the operation panel 201 of the user terminal 20. A transmission button 902 is a button (object) that acts as a trigger for transmitting a prompt input to the prompt input field 901 to the generative AI server 30. Inquiry sentences 903 and 905 are prompts that have been transmitted from the user terminal 20 and request a reply from the generative AI server 30. Answer sentences 904 and 906 are replies generated by the generative AI server, and are answers corresponding to the contents of inquiries that were made by the user in the inquiry sentences 903 and 905.

A print request prompt 907 is an example of a prompt for instructing the generative AI server 30 to perform printing. Upon receiving the prompt for issuing a print instruction, the generative AI server 30 transmits a plurality of pieces of log data and a print request to the extension application server 40. Although it is assumed in the present embodiment that every log on the same screen is transmitted as the transmitted pieces of log data, a part of past logs stored in the HDD 305 of the generative AI server 30 may be transmitted as print candidates. Alternatively, the extension application server 40 may be notified of a storage location that stores logs (a dialogue history), and the extension application server 40 may obtain necessary log data by accessing the storage location. Furthermore, the generative AI server 30 may transmit a part of logs to the extension application server 40 together with a print request, and the extension application server 40 may obtain log information that it lacks by accessing the storage location of logs as described above. Although the generative AI server 30 is as an example of the storage location of logs in the present embodiment, logs may be stored in a storage unit of another device different from the generative AI server 30.

A printed log selection response 908 is a response (selection object) for accepting, from the user, a selection of logs of prompts and responses to be printed. The printed log selection response 908 is transmitted from the extension application server to the generative AI server 30, and displayed on the browser of the user terminal 20. 909 is a list of logs, and displays a serial number and the beginning of text for each log received by the extension application server as a list. 910 represents checkboxes for the respective logs, and alternates between a selected state and an unselected state each time the user makes a selection. A transmission button 911 is a button for transmitting a print designation prompt based on the selected states of the checkboxes 910. The present embodiment presents an example in which a log selection is facilitated by the checkboxes. As another example, only the list 909 of pieces of log data with serial numbers may be transmitted as a response, and a user selection may be accepted by causing the user to input a serial number(s) to the prompt input field 901 and transmitting the same.

912 is a side bar, and displays pieces of log data in a state where they are managed and selectable in units of conversation groups. 913 is a new conversation button, and makes it possible to reset the display on the browser of the user terminal and transmit a prompt as a new conversation. 914 and 915 are objects indicating a past conversation log, and display a part of a prompt representing the beginning of the conversation log and the date and time of the last update. Operating these objects causes a corresponding conversation log to be displayed on a browser screen, and also makes it possible to transmit an additional prompt. 916 is a conversation that is currently displayed, and is displayed while being enhanced (in a bold frame).

FIG. 10 shows a dialogue screen 1000 that is displayed on the browser after the transmission button 911 has been operated in FIG. 9. A printed text selection response 1001 is in a state after the transmission of the print request, and the transmission button is not displayed therein. 1002 is a print designation prompt, which is transmitted automatically and displayed in the form of a prompt in response to an operation performed on the transmission button 911. Here, the content thereof designates printing of the second and fourth logs, which were placed in the selected state via the checkboxes 910. A print request response 1003 is a reply to the print designation prompt 1002, and has been generated by the generative AI server 30 in coordination with the extension application server 40. The print request response 1003 includes settings of printing to be performed from now, a reserved job URL 1004, and a preview image 1005. The preview image 1005 indicates that only the contents of the logs designated by the print designation prompt 1002 are included in an output material.

### Sequence

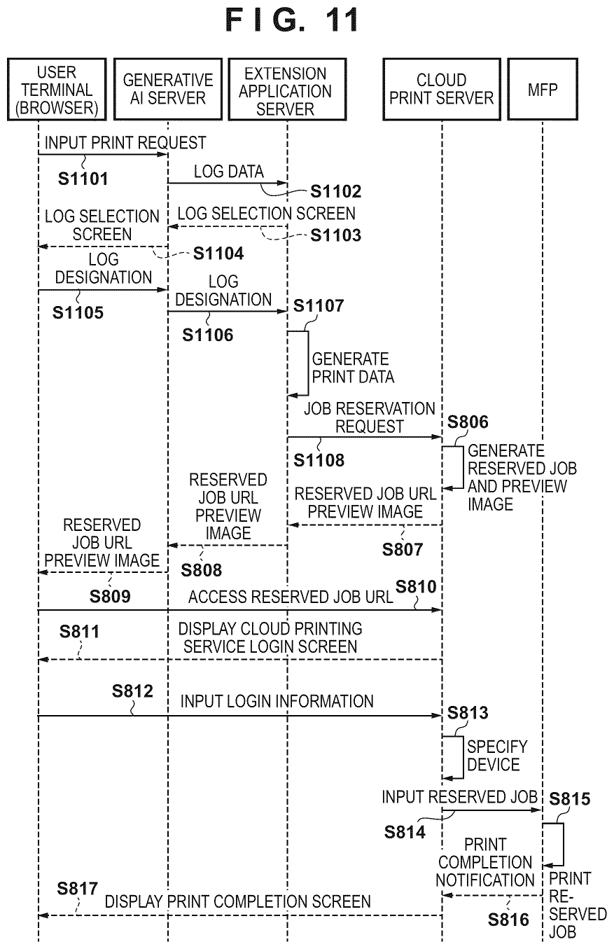

With reference to FIG. 11, a description is now given of a sequence of a dialogue between system constituent elements for a case where print logs are designated in the procedure of FIG. 9 and FIG. 10. Processing that is similar to FIG. 8 is given the same step numbers thereas, and a description thereof is omitted.

In step S1101, the user terminal 20 transmits the content input to the print request prompt 907 to the generative AI server 30 in accordance with a user input performed via the browser. In step S1102, the generative AI server 30 transmits a log data group that acts as print candidates to the extension application server 40. Regarding the transmitted log data group, it is possible to transmit all pieces of log data that are currently displayed, or it is possible to transmit only a part of the pieces of log data, such as only pieces of data that are currently displayed and only a dialogue history related to the current display content, in consideration of the trouble of designation. Alternatively, the number of transmitted pieces of log data may be equal to or smaller than a threshold, or only logs whose recording time and date are on or after a certain date and time may be transmitted. Alternatively, a range of logs that is transmitted in a case where a range is not designated by the print request prompt may be settable in advance as a setting of the extension application. Also, the content of the prompt that issues a print instruction may be interpreted, and pieces of log data that belong to a different conversation may be transmitted as print candidates. As an example, in response to a print prompt indicating “print a conversation about □□□”, pieces of log data included in the conversation log 914 can be transmitted. Alternatively, in response to a print prompt indicating “print an exchange on October 27”, pieces of log data included in the conversation log 915 can be transmitted.

In step S1103, the extension application server 40 generates the printed log selection response 908 from the log data group, and transmits the same to the generative AI server 30. In step S1104, the generative AI server 30 transmits the printed log selection response 908 to the user terminal 20, and the user terminal 20 displays the printed log selection response 908 on the browser.

In step S1105, the user terminal 20 transmits print designation information to the generative AI server 30 in response to an operation performed on the transmission button 911. In step S1106, the generative AI server 30 transmits the print designation information to the extension application server 40. In step S1107, the extension application server 40 generates print data from the designated pieces of log data. The print data is in a data format that can be accepted by the cloud print server 50, and can be, for example, a PDF file. Next, default print settings are stored as the current print settings. Although one piece of print data is generated from a plurality of pieces of log data that have been received in the present embodiment, one piece of print data may be generated for one piece of log data.

In step S1108, the extension application server 40 transmits a job reservation request to the cloud print server 50. At this time, the print data generated in step S1107 and the current print settings are transmitted together. From here on, the procedure of the sequence is similar to the procedure of the sequence of FIG. 8, and thus a description thereof is omitted.

### Processing Procedure of Extension Application Server

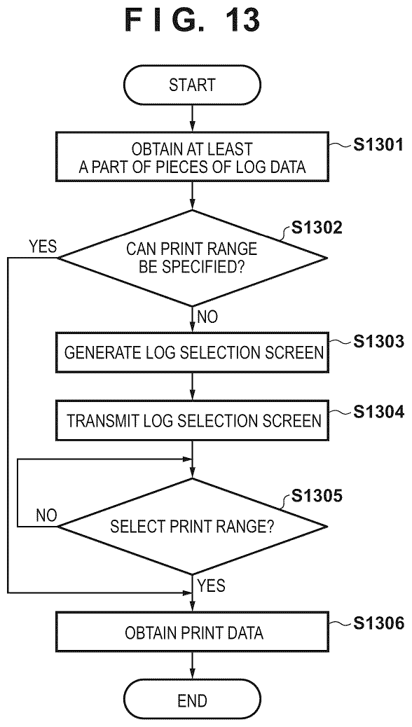

A processing procedure of the extension application server 40 according to the present embodiment will be described with reference to FIG. 13. FIG. 13 is detailed processing of step S1201 in the flowchart of FIG. 12. The processing described below is realized by, for example, the CPU 401 reading out a program stored in the ROM 402 into the RAM 403 and executing the program. Also, the following processing is realized by executing a plug-in that extends functions of the generative AI server 30. The present embodiment will be described under the assumption that this plug-in (program) is managed and executed by the extension application server 40; this, however, is not intended to limit the present invention. For example, the plug-in managed by the extension application server 40 may be installed on the generative AI server 30 and executed on the generative AI server 30. Alternatively, the generative AI server 30 and the extension application server 40 may be provided integrally; in this case, the integrated server controls management, installation, and execution of the plug-in.

In step S1301, the CPU 401 obtains at least a part of pieces of log data transmitted from the generative AI server 30. As stated earlier, at least a part of pieces of log data denotes a dialogue history that is currently displayed, a dialogue history related to the current display content, pieces of log data that fall within a predetermined threshold, pieces of log data within a predetermined time period, or the like. In step S1302, the CPU 401 determines whether a print range can be specified from the latest dialogue history. As stated earlier, a print range may be specified using any method; here, however, whether information required for the specification is included in the latest dialogue history is determined. For example, this determination is made based on whether this dialogue history includes a term with which a print range can be specified. In a case where a print range can be specified, processing proceeds to step S1306; otherwise, processing proceeds to step S1303.

In step S1303, as a print range cannot be specified, the CPU 401 generates a log selection screen (print request response 1003) for causing the user to designate a print range, and transmits information of the generated log selection screen to the generative AI server 30 in step S1304. The log selection screen is displayed on the operation panel 201 of the user terminal 20. In step S1305, the CPU 401 determines whether a user's designation of a print range has been accepted via the log selection screen displayed on the operation panel 201. If the designation has been accepted, processing proceeds to step S1306, the CPU 401 obtains print data corresponding to the print range, and processing of the present flowchart is ended. Note that in step S1306, if the designated print range is within the range of pieces of log data obtained in step S1301, processing is ended without newly obtaining data.

As described above, a computer program according to the present embodiment causes a computer of the information processing apparatus to make an inquiry about a plurality of options that act as candidates for a print range out of a dialogue history between the generative AI service and the user, which is included in a print request, via the generative AI service. Also, the present computer program causes the computer to specify one or more candidates for a print range selected from the plurality of options as a print range. This makes it easy to select and print only necessary information among pieces of information generated by the generative AI.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-009603, filed Jan. 25, 2024 which is hereby incorporated by reference herein in its entirety.

What is claimed is:

1. A non-transitory computer-readable storage medium storing a computer program that extends functions of a generative AI service, the computer program causing a computer of an information processing apparatus to function so as to
specify a print range upon receiving a print request via the generative AI service,
generate a print job based on the print request and the print range,
register the generated print job with a print server,
obtain information related to a connection destination for executing the print job from the print server, and
present the print job and the information related to the connection destination to a user via the generative AI service.

2. The non-transitory computer-readable storage medium according to claim 1, wherein
the computer program further causes the computer of the information processing apparatus to specify a print range from a dialogue history between the generative AI service and the user, the dialogue history being included in the print request.

3. The non-transitory computer-readable storage medium according to claim 1, wherein
the computer program further causes the computer of the information processing apparatus to make an inquiry about a plurality of options that act as candidates for a print range out of a dialogue history between the generative AI service and the user via the generative AI service, and to specify one or more candidates for the print range selected from among the plurality of options as the print range, the dialogue history being included in the print request.

4. The non-transitory computer-readable storage medium according to claim 3, wherein
the plurality of options include content of an input from the user, and content of a reply from the generative AI service.

5. The non-transitory computer-readable storage medium according to claim 2, wherein
the computer program further causes the computer of the information processing apparatus to obtain data representing a print range from a storage unit that stores the dialogue history in a predetermined time period.

6. The non-transitory computer-readable storage medium according to claim 5, wherein
the computer program further causes the computer of the information processing apparatus to present content of a print setting and a print preview image generated by the print server to the user as information of the print job.

7. The non-transitory computer-readable storage medium according to claim 6, wherein
the computer program further causes the computer of the information processing apparatus to generate print data by converting text data included in the print request accepted via the generative AI service into a format that is acceptable by the print server.

8. The non-transitory computer-readable storage medium according to claim 7, wherein
the computer program further causes the computer of the information processing apparatus to set a predetermined print setting with respect to the generated print job.

9. The non-transitory computer-readable storage medium according to claim 5, wherein
the computer program is incorporated in the computer as a plug-in for the generative AI service.

10. An information processing apparatus that executes a computer program that extends functions of a generative AI service, the information processing apparatus comprising:
one or more memory devices that store a set of instructions; and
one or more processors that execute the set of instructions to
specify a print range upon receiving a print request via the generative AI service,
generate a print job based on the print request and the print range,
register the generated print job with a print server,
obtain information related to a connection destination for executing the print job from the print server, and
present the print job and the information related to the connection destination to a user via the generative AI service.

11. A print system including an information processing apparatus, a print server, and an image forming apparatus, the information processing apparatus providing a generative AI service to a user terminal and comprising:
one or more first memory devices that store a set of instructions of a computer program that extends functions of the generative AI service; and
one or more first processors that execute the set of instructions to
specify a print range upon receiving a print request via the generative AI service,
generate a print job based on the print request and the print range,
register the generated print job with a print server,
obtain information related to a connection destination for executing the print job from the print server, and
present the print job and the information related to the connection destination to a user via the generative AI service,
the print server comprising:
one or more second memory devices that store a set of instructions; and
one or more second processors that execute the set of instructions to
provide the information related to the connection destination when the print job has been registered, and
input the print job to the image forming apparatus when the user has accessed the information related to the connection destination.

12. The print system according to claim 11, wherein
the print server is a cloud print server.
